(19) United States
(12) Patent Application Publication
(10) Pub. No.: US 2007/0034423 A1
(43) Pub. Date: Feb. 15, 2007

(54) Touch screen having reduced susceptibility to radio frequency interference

(76) Inventors: Thomas J. Rebeschi, Merrimack, NH (US); Bruce A. Lessard, Salem, MA (US); Richard A. Peterson JR., Chelmsford, MA (US); Gordon F. Taylor, Bolton, MA (US)

Correspondence Address: 3M INNOVATIVE PROPERTIES COMPANY, PO BOX 33427, ST. PAUL, MN, 55133-3427, US

(21) Appl. No.: 11/202,983

(22) Filed: Aug. 12, 2005

(51) Int. Cl. G08C 21/00

(52) U.S. Cl. 178/18.06

(57) ABSTRACT

Systems and methods are disclosed for reducing susceptibility of touch screens to RF interference, thereby reducing susceptibility to touch position errors due to RF interference. In touch screen systems having touch sensors that lack a rear shield, the rear shield drive of the controller electronics can be capacitively connected individually to the touch signal drives, thereby placing a capacitive load on the touch signal drives that simulates the capacitive load that would otherwise be provided by a rear shield. This capacitive load compensates for the RF interference, which would otherwise tend to erroneously offset touch position determinations toward the center of the touch screen.

The present invention relates to touch screens and to reducing RF susceptibility in touch screens.

### BACKGROUND

Touch input devices can provide a convenient and intuitive way for a user to interact with an electronic system such as a computer, video game, public information kiosk, automotive navigation system, and so forth. Many of these systems include displays positioned behind the touch sensor and in close proximity so that the display is viewed through the touch sensor. The various touch sensing technologies include those known in the art as capacitive, projected capacitive, resistive, surface acoustic wave, and infrared.

### SUMMARY OF THE INVENTION

The present application discloses a touch screen system that includes a touch sensitive layer disposed on a touch screen substrate, controller electronics configured to apply substantially equivalent signals to a plurality of touch signal drives and an auxiliary drive, where each touch signal drive is coupled to the auxiliary drive through an associated capacitor. The controller electronics are further configured to determine touch input position based on signals received in response to a touch coupled to the touch sensitive layer. A plurality of touch signal lines couple the touch signal drives to the touch sensitive layer so that touch signals can be communicated to the controller. The associated capacitors can be selected to reduce susceptibility to errors in touch position determination due to RF interference, and in certain embodiments can be located on the touch screen substrate, on an electrical tail connecting the controller electronics to the touch sensitive layer, on a circuit board separate from the controller electronics, on a circuit board associated with the controller electronics, and so forth. In addition to reducing RF susceptibility in touch screens lacking a rear shield, the capacitors can function to further reduce RF susceptibility in touch screens that include a rear shield.

Methods are also disclosed for reducing susceptibility to errors in touch position determinations due to RF interference in a touch screen system. The methods include steps of providing a touch sensor of the touch screen system, the touch sensor including a touch sensitive layer disposed on a substrate and lacking a rear shield, providing controller electronics coupled to the touch sensor, the controller electronics configured to apply substantially equivalent signals to a plurality of touch signal drives and an auxiliary drive, and further configured to determine touch input position based on signals received in response to a touch coupled to the touch sensitive layer, and individually connecting each touch signal drive to the auxiliary drive through associated capacitors.

Also disclosed are methods for simulating effects of a rear shield in a capacitive touch sensor lacking a rear shield, the methods including connecting each of a plurality of touch signal drive lines to an auxiliary drive line, each connection made through a capacitor, and applying substantially equivalent signals to the signal drives lines and auxiliary drive line.

The above summary is not intended to be limiting, or to describe each embodiment or every implementation of the claimed invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a schematic representation of a capacitive touch screen system that includes a rear shield.

FIG. 2 is a schematic representation of a capacitive touch screen system that includes capacitors connected to an auxiliary drive of the controller electronics to simulate the capacitance that would otherwise be provided by a rear shield.

FIG. 3 is a schematic circuit diagram of capacitive connections between the corner drives and auxiliary drive of a touch screen controller.

FIG. 4 is a schematic representation of a touch sensor and electronic tail having corner drive lines and an auxiliary drive line.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

The teachings of the present application can be used to reduce susceptibility of touch input systems to radiated radio frequency (RF) interference, particularly in touch input systems incorporating a capacitive touch sensor that lacks a shielding layer that would otherwise help reduce RF susceptibility, but also to further reduce RF susceptibility in touch input systems that include a rear shield. The effects of a rear shield that tend to reduce RF susceptibility can be simulated, for example, by providing capacitors that couple the rear shield drive (or auxiliary drive for a touch screen system that lacks a rear shield) to the sensing layer touch signal drives to simulate the capacitive coupling that takes place between the sensing layer and rear shield and acts to cancel at least a portion of the RF signal. Reducing RF susceptibility reduces touch position errors that can be caused by the RF interference.

Touch screen controllers can be susceptible to RF conducted into the power cables, video cables, serial cable, or USB cables, and to RF radiated into the touch screen. In particular, it has been observed that certain capacitive touch screen controllers connected to capacitive sensors without a rear shield layer can be on the order of twice as susceptible to RF as compared to the same controllers connected to capacitive sensors having a rear shield layer. For the sake of clarity, and without the loss of generality, the example of capacitive touch screens will be used in the description that follows, but the reader will understand that the teachings can be applied to other types of touch screens having susceptibility to errors caused by RF interference.

The rear shield produces several nano-Farads (nF) of capacitance to the touch sensitive surface of a capacitive touch screen. The rear shield is generally provided as a transparent conductive coating on the back (display facing) surface of a touch screen. The rear shield is connected to a rear shield drive on the touch screen controller. The rear shield drive duplicates the signals sent on the corner (touch signal) drives to the touch sensitive layer. Because the rear shield and corner drive signals are equivalent (i.e., same waveform, same voltage), the controller corner drive does not experience any extra loading from the rear shield. The capacitance is only detected when an external noise signal is injected into the touch screen, and the detection of such can be used to help reduce any undesirable effects of the external noise.

Without a rear shield, an RF signal can couple directly into the four corner inputs of a capacitive touch screen controller. The RF signal acts equally on all four inputs, and as such is termed a “common mode” signal. Such common mode signals are generally not seen by the controller as noise, and therefore can be undesirably included in the touch location determination, introducing error. When a user touches a capacitive touch screen, the user becomes a load to the RF signal and draws current from each corner of the touch screen. Depending on the location of the touch, if not directly in the center, the user will draw more current from the corner or corners nearest to the touch location, causing a differential RF signal to appear at the controller. This RF signal causes an offset in the touch position depending on the signal voltage level and specific frequency.

The RF susceptibility can be reduced substantially by adding filter capacitors between the controller's rear shield drive (auxiliary drive when no rear shield exists) and each touch signal drive. By doing so, even though a rear shield may not exist on the touch sensor, the added capacitors can act to simulate the capacitance that a touch screen rear shield would have otherwise produced.

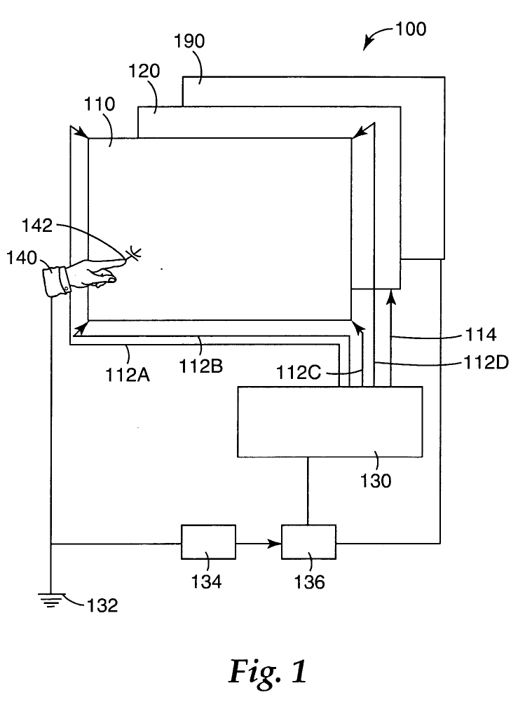

FIG. 1 shows a schematic block diagram of a capacitive touch screen system 100 that includes a touch screen having a touch sensing layer 110 and a rear shield layer 120, and an optional display device 190 positioned to be viewable through the touch screen. Touch screen controller 130 applies signals to the touch sensing layer 110 through four corner drives 112A-112D, and applies signals to the rear shield 120 through rear shield drive 114. The rear shield 120 is driven with the same waveform and voltage (i.e., equivalent signal) as the four corner drives 112A-112D. A capacitively coupled touch 142 to the touch sensitive layer 110 by a user 140 draws current through each of the corners of the touch sensitive layer 110, the amount of current is proportionally related to the distance between the touch location and the corner. The controller 130 can use this information to determine touch position.

A Conducted Radio Frequency Immunity (CRFI) test can be conducted to determine RF interference susceptibility. In the CRFI test, controlled levels of RF voltage (3 V/M as per commercial specifications) at various frequencies over a range (e.g., 150 KHZ to 80 MHZ) are injected into the controller power and signal lines individually and simultaneously. The RF can also be injected into the display's video and power cables, because the controller is mounted within the display device housing. The touch screen is then operated by a user that draws continuous vertical and horizontal lines. As the frequency is stepped through its range, for example in 0.1% increments, any deviation in the line position is monitored. Failure conditions can be defined based on deviations of the lines by more than an acceptable amount, for example by more than +/−1% of the screen diagonal. If a sensitive frequency point is noted, the frequency is adjusted by hand to find a peak deviation.

Referring again to FIG. 1, during a CRFI test, the common ground 136 is driven by an RF signal 134 at various frequencies and at 3 V/M. The RF is a common mode signal in that the RF drives everything equally. The common ground 136, the corner drives 112A-112D, and the back shield drive 114 all have the same RF signal on them. When the user 140 touches the screen, the user is referenced to the earth ground 132, and as such acts as a load to the RF signal 134 as well as a touch signal to the controller 130. The RF is not seen as a signal until the user touches the screen. When the touch occurs, the RF signal acting on the corner drives causes an offset in the touch position on the screen, and because the RF acts the same on all corners, the offset acts to move the apparent touch position towards the center of the screen. However, in a capacitive touch screen having a rear shield, such as shown in FIG. 1, the capacitance between the touch sensing layer 110 and rear shield layer 120 acts as low impedance to the RF interference. The RF current is supplied by the touch signal corner drives and also by the rear shield drive through the coupling capacitance of the touch screen rear shield. This divider action reduces the RF into the corner drives and reduces the positional offset due to the RF interference.

Some capacitive touch screens do not utilize a rear shield, even though they may still utilize electronics platforms that support a rear shield drive. In such touch screens, all of the RF signal is seen by the corner drives so that a relatively large touch position offset may be observed. The offset is largest when touching or tracing at or near the edges of the screen, and is reduced near the center. According to the present invention, capacitors can be added externally to the controller that individually connect the rear shield drive to each of the corner drives to simulate the back shield capacitance on the touch screen. These capacitors provide a low impedance path for the RF signal, thereby reducing the RF induced current into the touch screen corners and correspondingly reducing the touch position offset.

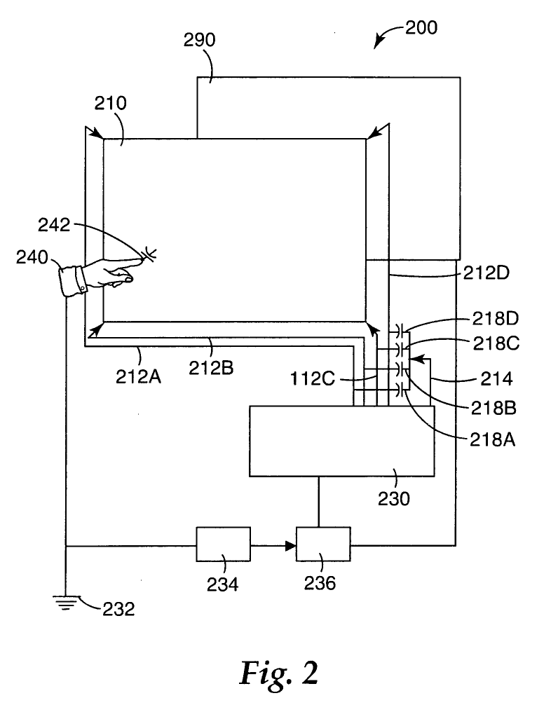

FIG. 2 shows a schematic block diagram of a capacitive touch screen system 200 that includes a touch sensitive layer 210 of a touch screen disposed in front of an optional display device 290, where the touch screen does not include a rear shield. A controller 230 connects to the touch sensitive layer 210 through corner drives 212A-212D. The controller also includes an auxiliary drive 214 that would drive the rear shield for a touch screen that had a rear shield. As such, the auxiliary drive is driven with a substantially equivalent signal as the corner drives. Each corner drive 212A-212D is connected to the auxiliary drive 214 through capacitors 218A-218D. FIG. 2 also indicates a user 240 applying a touch 242 that is capacitively coupled to the touch sensing layer 210, an earth ground 232, an RF signal 234, and a system common ground 236.

By way of example, for a 17-inch diagonal capacitive touch screen without a rear shield connected to touch screen controller electronics such as the electronics available from 3M Touch Systems, Inc. under the trade designation EX II, adding capacitors between the corner drives and the rear shield drive having capacitances of about 1000 pF to 3000 pF, preferably about 1500 pF, can sufficiently simulate the capacitance that would otherwise be provided by a rear shield. The extra capacitance is not seen as a load by the controller if it is driven with identical, or near identical, waveforms between the corner drive and the auxiliary (i.e., rear shield) drive, and as such no extra power is required, and only the load from the touch is driven by the added capacitors. A 17-inch capacitive touch screen available from 3M Touch Systems, Inc. under the trade designation MicroTouch™ Cleartek II, having no rear shield and utilizing 1500 pF capacitors between the corner drives and the rear shield drive of an EX II controller was tested at up to double the normal RF testing voltage (i.e., 6 V/M), and it passed the CRFI test. Such performance is better than the performance of a typical rear shield equipped capacitive touch screen, and as such adding capacitors as described in the present invention can also be used to improve the performance of touch screen systems including a rear shield.

The EX II controller uses a narrow band signal to measure capacitance and is thus susceptible to harmonics of the fundamental controller operating frequency. The RF susceptibility test steps through the RF frequency band in 0.1% increments so most harmonics of the controller are found. The test requires the RF frequency to be adjusted to maximize the effect when a resonance is found. Several circuit components are included in the EX II controller to reduce such effects, such components including a decoupling capacitor connected to ground and a series connected ferrite element on each corner drive. These circuit elements help reduce the RF signal before it is received in the EX II ASIC. These circuits are sufficient when used with capacitive touch screens having a rear shield.

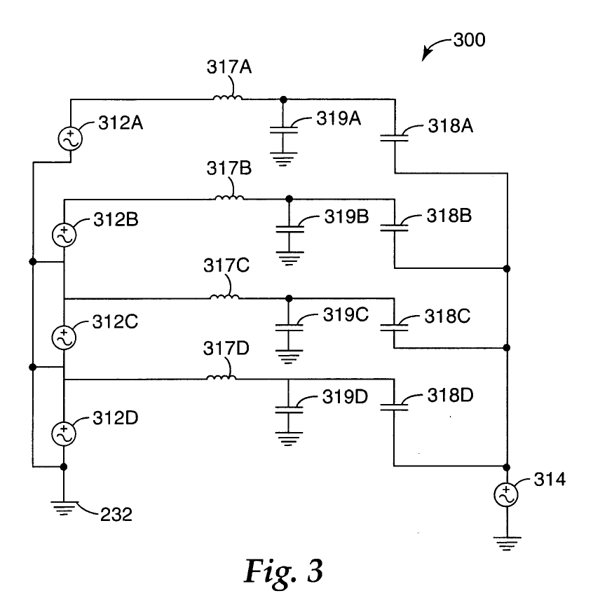

FIG. 3 shows a schematic diagram of a portion of the circuit that includes the touch screen corner drives 312A-312D, the rear shield drive 314, and capacitors 318A-318D added between the rear shield drive and each corresponding corner drive to simulate the RF reducing effects of a rear shield. Also shown in the corner drive circuits are ferrites 317A-317D and decoupling capacitors 319A-319D such as the standard ferrites and 100 pF filter capacitors already present in the EX II controllers.

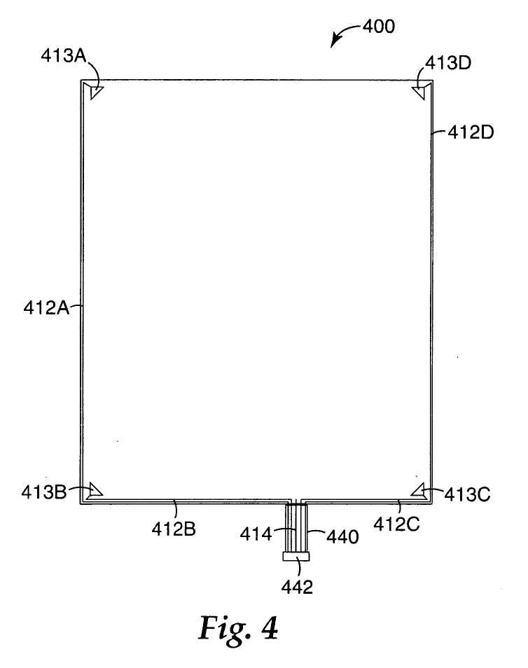

FIG. 4 shows a touch sensor 410 that includes corner drive lines 412A-412D that lead from an electronic tail 440 to corner electrodes 413A-413D. The corner electrodes provide the signals to an electrode pattern (not shown) designed to provide a linearized electric field across the sensor surface. The tail 440 and sensor 410 also include an auxiliary drive line 414. The tail can include a connector 442 for coupling to the controller electronics (not shown). According to the present invention, when capacitors are used to connect the corner drives to the auxiliary drive to simulate a rear shield capacitance, the capacitors can be located in various locations including on the touch sensor substrate (for example near where the tail 440 couples to the sensor), on the tail 440, in the connector 442, between the tail 440 and the controller electronics (for example on an extender circuit board, flex circuit, connector, and so forth), or directly on the controller electronics board. One exemplary implementation involves attaching surface mount capacitors on the back side of the controller board and wiring to the appropriate pins on the sensor connector.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A touch screen system comprising:
a touch sensor comprising a touch sensitive layer;
controller electronics configured to apply substantially equivalent signals to a plurality of touch signal drives and an auxiliary drive, each touch signal drive being coupled to the auxiliary drive through associated capacitors, the controller electronics further configured to determine touch input position based on signals received in response to a touch coupled to the touch sensitive layer; and
a plurality of touch signal lines coupling the touch signal drives to the touch sensitive layer.

2. The touch screen system of claim 1, wherein the associated capacitors are selected to reduce susceptibility to errors in touch position determination due to RF interference.

3. The touch screen system of claim 1, wherein the associated capacitors are located on the touch sensor.

4. The touch screen system of claim 1, wherein the associated capacitors are located on an electrical tail connecting the controller electronics to the touch sensitive layer.

5. The touch screen system of claim 1, wherein the associated capacitors are located on a circuit board separate from the controller electronics.

6. The touch screen system of claim 1, wherein the associated capacitors are located on a circuit board associated with the controller electronics.

7. The touch screen system of claim 1, wherein the associated capacitors have capacitances in a range of about 1000 nF to 3000 nF.

8. The touch screen system of claim 1, wherein the touch sensor is a capacitive touch sensor.

9. The touch screen system of claim 1, wherein the touch sensor lacks a rear shield.

10. The touch screen system of claim 1, wherein the touch sensor further includes a substrate on which the touch sensitive layer is disposed, and wherein a rear shield is disposed on a surface of the substrate opposing the touch sensitive layer.

11. A method for reducing susceptibility to errors in touch position determinations due to RF interference in a touch screen system comprising:
providing a touch sensor of the touch screen system, the touch sensor including a touch sensitive layer disposed on a substrate and lacking a rear shield;
providing controller electronics coupled to the touch sensor, the controller electronics configured to apply substantially equivalent signals to a plurality of touch signal drives and an auxiliary drive, and further configured to determine touch input position based on signals received in response to a touch coupled to the touch sensitive layer; and
individually connecting each touch signal drive to the auxiliary drive through associated capacitors.

12. A method for simulating effects of a rear shield in a capacitive touch sensor lacking a rear shield comprising:
connecting each of a plurality of touch signal drive lines to an auxiliary drive line, each connection made through a capacitor; and
applying substantially equivalent signals to the touch signal drives lines and auxiliary drive line.
